(19) United States
(12) Patent Application Publication
(10) Pub. No.: US 2026/0037864 A1
(43) Pub. Date: Feb. 5, 2026

(54) SYSTEM AND METHOD FOR EFFICIENT, SCALABLE, AND EXTENSIBLE AI MODEL INTEGRATION IN A CLOUD-BASED APPLICATION SERVICE

(71) Applicant: Salesforce, Inc., San Francisco, CA (US)

(72) Inventors: Daryl Martis, New York, NY (US); Stefan Eberl, Moraga, CA (US); Ashish Thapliyal, Frisco, TX (US); Palaniappa Manivasagam Ramanathan, Bangalore (IN); Preet Sagar, Bhiwani (IN); George Zhang, Okotoks (CA); Ekansh Gupta, Union City, CA (US)

(73) Assignee: Salesforce, Inc., San Francisco, CA (US)

(21) Appl. No.: 18/792,569

(22) Filed: Aug. 2, 2024

(51) Int. Cl. G06N 20/00

(52) U.S. Cl. CPC G06N 20/00

(57) ABSTRACT

Apparatus and method for integrating external AI services. For example, one embodiment of a method comprises: preparing training data received from various data streams on the cloud-based application service, wherein preparing includes categorizing, filtering, and curating data from the data streams; generating source data model objects (DMOs) based on training data; providing the source DMOs to the external AI service over a secure communication channel, the external AI service to register an AI model based on the source DMOs and to generate a corresponding AI model endpoint; executing an AI model builder on the cloud-based application service, the AI model builder to generate an AI model reference configurable with connection information to communicate with the AI model endpoint, the AI model builder configurable to automatically trigger an inference when data mapped to an input of the AI model is changed in one or more of the source DMOs.

### TECHNICAL FIELD

One or more implementations relate to the field of computer systems for providing data processing services; and more specifically, to a system and method for efficient, scalable, and extensible AI model integration in a cloud-based application service.

### BACKGROUND ART

Organizations in every industry sector are hastily attempting to integrate artificial intelligence (AI) technologies into their information technology (IT) platforms in anticipation of the potential positive impact on their businesses. Given the pressure on IT personnel to integrate AI solutions as quickly as possible, these solutions are often performed in a haphazard manner, resulting in a patchwork of unstable implementations with unanticipated problems, including cost overruns.

One significant limitation with integration of AI model engines is that trained AI models cannot be efficiently and securely ported across cloud-based platforms. There is currently no standard way to securely use an AI model to evaluate proprietary data of an organization. For example, no turnkey solutions exist for securely training and utilizing AI models provided by AI model service providers (e.g., Microsoft Azure, Amazon Web Services (AWS), and Google Cloud) using an organization's confidential data.

There are two general types of artificial intelligence (AI): Generative AI and Predictive AI. Generative AI generates content such as text, video, and images using machine learning with generative AI models whereas predictive AI identifies patterns in historical data predict future outcomes.

Predictive AI models rely on statistical techniques, regression models, and time series to predict the likelihood of future outcomes based on historical data. For example, financial markets use predictive AI models to make informed decisions related to investments, currencies, and commodities. Healthcare industries use predictive AI models to evaluate potential patient outcomes and drug efficacy and meteorologists use predictive models to anticipate future weather conditions.

Generative AI models include large language models (LLMs) such as Generative Pre-trained Transformer (GPT) models (e.g., GPT-4) which can write essays, poems, and even program code snippets in response to user prompts. Generative AI models based on generative adversarial networks (GANs) can produce art and music compositions. StyleGANs can perform image synthesis to create realistic faces and landscapes. The challenges associated with generative AI models include bias, overfitting, and processing and storage requirements for processing large amounts of training data.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 illustrates an implementation of a cloud-based application platform utilizing AI models from different AI service providers.

FIG. 2 illustrates additional details for one implementation in which an AI model builder manages data sharing with an AI model platform.

FIGS. 3A-B illustrate a method in accordance with various implementations of the invention.

FIGS. 4A-H illustrate various aspects of a model builder in accordance with embodiments of the invention.

FIG. 5 illustrates a specific implementation for securely processing large language models (LLMs) via an LLM gateway of an LLM model provider.

FIG. 6A is a block diagram illustrating an electronic device according to some example implementations; and

FIG. 6B is a block diagram of a deployment environment according to some example implementations.

### DETAILED DESCRIPTION

### A. Introduction

Implementations of this disclosure include a system and method which allows organizations (e.g., businesses, governmental organizations, educational institutions, charitable institutions, etc) to leverage proprietary, real-time customer data from their internal data cloud infrastructure to train AI models to improve efficiency and solve specific business needs. In accordance with these embodiments, organizations train a preferred AI model within their own data cloud, which connects all data from any data source, and automatically harmonizes that data into a single customer profile that adapts to each customer's activity. These implementations can be configured to operate dynamically, in real time for use across any organization as well as any departments or divisions within an organization. Note that the term “data cloud,” sometimes referred to as a “data service,” is used herein to refer to an internal or cloud-based infrastructure and corresponding services for managing an organization's data.

Some implementations described herein provide efficient training of selected AI models using pre-configured, zero-ETL (extract, transform, and load) requirements, which reduces the complexity of moving data between platforms. In some implementations, a graphical user interface (GUI) with intuitive features allows an administrator of a data cloud to evaluate, filter and curate a representative subset of data from the organization's data cloud from which custom AI models can be constructed and trained for use across the organization's cloud-based application framework. These features provide for efficient curating of current and highly relevant customer data to accurately inform AI predictions and auto-generate results.

This zero-ETL framework allows organizations to power custom AI models without performing time-consuming and error-prone data integration across various types of information systems (e.g., extracting the data, transforming/normalizing the data, and loading the data). Consequently, an organization's data cloud can be connected to other AI tools without the extract, transform, and load (ETL) process, saving time and cost while seamlessly accelerating AI implementations.

These implementations import AI model inferences to a data cloud, potentially within a larger cloud-based application service. One example is the Salesforce Data Cloud which operates within the Salesforce cloud-based software platform, although the underlying principles of the invention are not limited to any specific software platforms. Once imported, the AI model inferences can be utilized within the cloud-based application ecosystem (e.g., added as an option within existing cloud-based applications or directly accessible via a browser).

Some implementations of this disclosure include a combination of (i) a contract abstraction which provides for the importation of inferences from any external AI model provider using a standardized opinionated contract based on AI model capabilities (e.g., summarization, classification, multiclass-classification, text generation, etc.) and (ii) a customization engine which implements custom components against these standard capabilities within the cloud-based application service, using data from the organization's data cloud.

### B. AI Model Training and Management

By way of an overview, during training, an AI model consumes large amounts of pre-labeled training data based on which the AI model learns the correct or desired output for a given input. The AI model may be further trained by running it on random or unlabeled input data and providing feedback to inform the AI model whether its results were correct or incorrect for each input. For example, a model trained to detect among different types of documents may be provided with thousands or millions of pre-labeled documents so that the AI model can learn the visual characteristics and text contents of the documents needed to generate accurate results.

The AI model gains knowledge through the training process. When in operation, the AI model relies on this knowledge base to generate results based on live input data without user intervention. The AI model accepts input data from users, performs various levels of processing of the data (e.g., normalization and formatting of the data) so that it can be interpreted by the AI model, which generates the output. The more thoroughly trained an AI model is, the more accurate its inferences will be. Some implementations continue to train and customize AI models with user data from the organization's data cloud during operation (e.g., continually providing feedback to the AI model so that it can make more accurate decisions). Users of the cloud-based application service can then use their customizations in combination with turnkey AI models (such as large language models (LLMs)), efficiently enabling trusted, open, and real-time AI experiences to each application and workflow.

### C. Example Implementations of the Invention

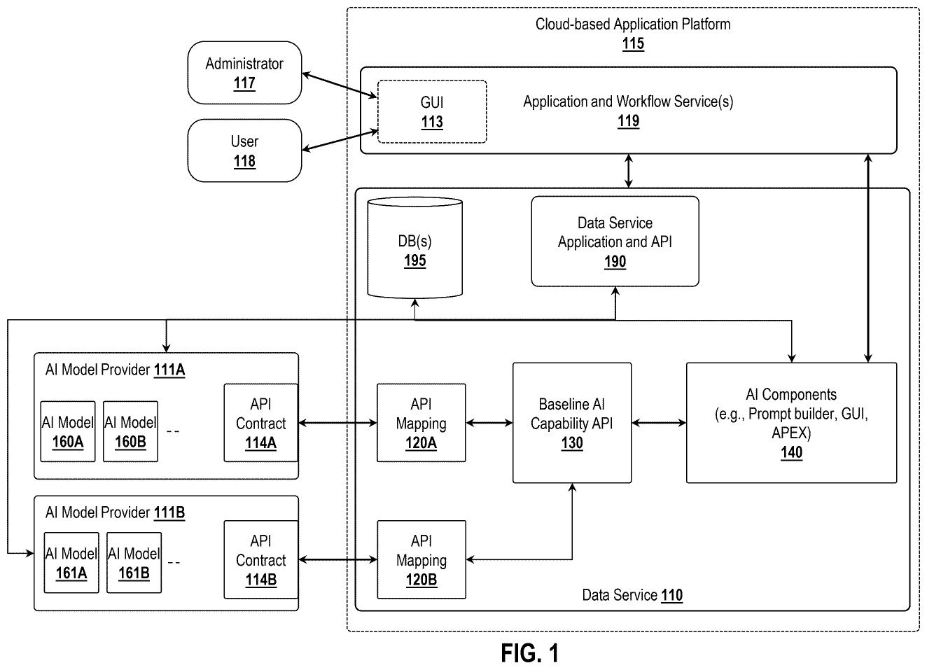

FIG. 1 illustrates an example implementation of a cloud-based application platform 115 which seamlessly provides access to AI models 160A-B and 161A-B from respective AI model providers 111A and 111B in accordance with respective API model contracts 114A-B. As used herein, the API model contracts 114A-B define the specific sets of requests, responses, and transactions, including data formatting requirements for accessing the respective API models 160A-B, 161A-B. The API models can then be leveraged using real-time data dynamically managed from the organization's data service 110 as described herein.

The cloud-based application platform 115 provides access to application and workflow services 119 which rely on the underlying data managed by the data service 110. While the illustrated example with be described with respect to a single organization, the cloud-based application platform 116 may concurrently provide these described implementations for a variety of different organizations, securely partitioning data storage, processing, and network resources of the cloud-based application platform 115.

The application and workflow services 119 provide various cloud-based applications and related software components provided to end users. The application components can include, but are not limited to, dataflows, recipes, data model objects (DMO), activations, and list record views. Many of these components request and process certain types of data from the data service 110. Administrators 117 and users 118 may access the application and workflow services 119 via a GUI 113 which may provide different functionality for administrators and/or users with different permission levels, including functionality related to evaluating data with AI models. The data service application and API 190 comprises a central point of communication between the application and workflow services 119 and the data service 110.

A baseline AI capability API 130 defines the basic set of AI model functions required by the integrated AI components for incorporating AI model functionality into the data service platform 110. The AI model availability and functionality is expressed by each AI model provider 111A-B in the form of an API contract, which the API mapping logic 120A-B translates to define the baseline availability and capabilities of the corresponding AI models 160A-B, 161A-B. For example, the API mapping logic 120A-B may translate the API contract details into a normalized format in the baseline AI capability API, which can then be accessed by the API components 140 during the development process. The API contracts 114A-B are provider-specific data structures which is interpreted and translated by the corresponding API mapping logic 120A-B. Administrators or developers can then design the standard or custom API components 140 based on the baseline AP capability API (e.g., which may provide prompt builder software, custom applications development using custom/standard components and with access to custom and/or standard AI model providers).

The API mapping component(s) 120A-B may include some relatively straightforward mappings to corresponding API contract commands (e.g., which perform the same functions but using different naming conventions or request formats), as well as more complex mappings such as sequences of transactions defined in the API contracts 114A-B which the API mapping components 120A-B translate into a sequence of baseline API capability API transactions to achieve the desired result. Thus, the API mapping component 120A-B is capable of interacting with the exposed API contracts 114A-B to provide access the corresponding AI models of the AI model providers 111A-B without significant user intervention or knowledge of the underlying details of the API contracts 114A-B.

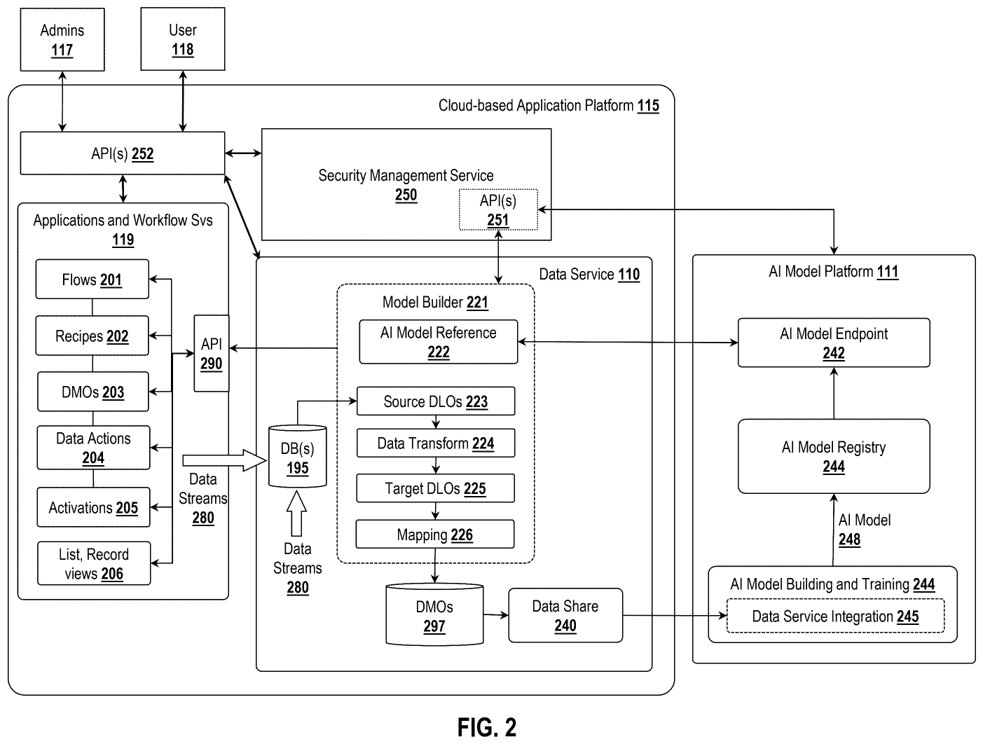

FIG. 2 illustrates additional details of the cloud-based application platform 115, including the application and workflow service 119, the data service 110, interactions with a corresponding AI model platform 111, and a security management service 250 for performing authentication and other security mechanisms for interacting with the AI model platform 111, as well as for interactions between the various services internal to the cloud-based application platform 115. A large set of components of the application and workflow services 119 are accessible to admins 117 and users 118 including, but not limited to, flows 201, recipes 202, DMOs 203, data actions 204, activations 205, and list, record views 206, all of which communicate with the data service 110 via one or more APIs 290. Note that admins 117 are simply users 118 with a heightened level of privileges for configuring operations of the cloud-based application platform 115.

### D. Collecting and Extracting Data from the Data Service

In operation, various types of data from different data sources 290 are streamed to the data service 110 and temporarily stored in the database 195 (or other storage devices). A data transform logic 224 of the model builder 222 transforms the raw source data lake objects (DLOs) 223 collected from the data streams 280 in accordance with a set of rules to generate target (DLOs) 223. Because the data originates from multiple sources 280, it can be normalized or denormalized. If denormalized, the data transform logic 224 converts the denormalized source DLOs 223 into target DMOs 225 having a normalized format required for mapping to the data model supported by the data service 110.

In some implementations, DLOs are storage containers within the data service 110 that hold data that has been ingested into all data streams 280. During ingestion, the data service 110 retrieves a sample of data and recommends a source schema, which can be accepted or modified. In the schema, the non-editable header label identifies the source of the raw data. The recommended schema can include a field label, a proposed Data Cloud display name for each source header column; a field API name, a proposed data service 110 API name for each source header column; and a data Type, a suggested data type for each source header column.

Mapping logic 226 transforms the target DLOs 225 into data model objects (DMOs) comprising a harmonized grouping of data created in accordance with a defined schema which can be interpreted and processed by the data service integration logic 245 of the AI model building and training logic 244 of the AI model platform 111. The DMOs are provided as a data share 240 to the data service integration logic 245.

A variety of mechanisms are provided for collecting, filtering, and organizing data sources 280 in the data service 110. The APIs 252 include a data service metadata API which responds to metadata requests related to all entities, including calculated insights, engagement, profile, and other entities, and their relationships to other objects. For data lake objects (DLOs) and data model objects (DMOs), the API 252 response also includes information about key qualifier fields. For each DLO field and DMO field, the API 353 response includes the name of the associated key qualifier field. To query metadata and data from data graphs, the APIs 252 also include data graph APIs to query metadata and data from data graphs, data service profile APIs which are used to look up and search customer profile information. These API calls can be included in external web or mobile apps to look up customer profile information.

Certain query APIs support SQL queries in an ANSI standard format, resulting in results comprising an array of records. The expected input using these query APIs is free form SQL. The input objects include data stream, profile and engagement data model objects, and unified data model objects. The query APIs support a variety of use cases, which includes large volume data reads, external application integration, or interactive on demand querying on the data lake.

The APIs 252 may also include unified record ID queries which use a universal ID to perform a lookup to retrieve all individual records associated with a unified record. Queries can be generated on an Individual ID from one source and retrieve all the individual IDs for that individual from other data sources.

In addition, the APIs 252 include a query API to provide access to a customer data platform (CDP) Python connector which extracts data from data service 110 into Python, allowing fetching of data from certain types of platforms (e.g., Pandas DataFrames) which can be used to create visual data models, perform powerful analytical operations, or build powerful machine learning and AI models. In some implementations, the data service integration 245 used by AI model building and training 244 is implemented using the data cloud Python SDK.

In some implementations, the data service 110 supports webhook data action targets. A data service 110 data action event can be sent to a webhook target using a secret key generated by the security management service 250 to protect the message integrity. A webhook is an event-driven (rather than request-driven) type of HTTP request triggered by an event in a source system (e.g., the data service 110) and sent to a destination system with a payload. Webhooks are sent automatically when an event is triggered. The secret key based signature validates the payload requests sent from the data service 110.

### E. Security Management

In all of these embodiments, identity resolution performed by the security management service 250 may be used to consolidate data from different sources 280 into comprehensive views of customers and accounts. Identity resolution uses matching and reconciliation rules to link data about people or accounts into unified profiles, each of which contains all the unique contact point values from all sources. Identity resolution rulesets may be configured after mapping source data 280 to data model objects (DMOs).

In some implementations, the security management service 250 secures access to the data share 240 by the data service integration engine 245 as the data exchanged between the model builder 221 and the AI model endpoint 242. In some embodiments, all users 118 and administrators 117 of the cloud-based application platform 115 are registered with the security management service 250 which provides a set of permissions for accessing the various services and data described herein. Authentication may be performed via a user name and password, or more advanced security mechanisms such as two-factor authentication and/or biometric authentication. In some embodiments, the user credentials are validated before each transaction with the data service 110 and the AI model platform 111.

Identity resolution rulesets may also be implemented through coordination with the security management service 250. Rulesets contain match and reconciliation rules that instruct the data service 110 how to link multiple sources of data 280 into a unified profile. Unified profile information is stored in data lake objects 225 created by the ruleset. Each ruleset job processes source profiles according to the mapping, matching, and reconciliation rules configured to create and update unified profiles. Identity resolution also consolidates all field values from multiple data sources 280 info unified profiles that can be used in processes such as segmentation and activation, calculated insights, reporting, and more. Unification is determined based on the created data mappings and on the match and reconciliation rules specified in the ruleset.

### F. AI Model Integration

The data share 240 (including the DMOs 297) is securely provided to the AI model building and training logic 244, which responsively builds and trains an AI model 248 (e.g., based on the particular type of AI model selected). In one implementation, the data service integration 245 comprises a data cloud Python SDK and the AI model building and training logic 244 comprises a Google Vertex AI engine, although the underlying principles of the invention are not limited to any particular AI engine provider or any type of AI engine. The constructed AI model 248 and associated metadata are stored and indexed in an AI model registry 244. An AI model endpoint 242 is generated based on the model data and metadata in the AI model registry 244.

The model builder 221 generates a corresponding AI model reference 222 which connects to the AI model endpoint 242. The AI model reference 222 acts as a local proxy for the corresponding AI model stored in the AI model registry 244, servicing AI requests from the various applications and workflow services 119 of the cloud-based application platform 110. As described further below, the AI model endpoint 242 is accessible via a URL which can be automatically or manually entered in the model builder 221. Additionally, a separate AI development tool or set of tools may be provided by the cloud-based application platform 115 to allow developers to access, configure, and fine-tune AI models via the AI model endpoint.

Thus, in accordance with these embodiments, data from diverse sources are consolidated and prepared using the data service's 110 data lake object technology and batch data transformations to create a training dataset. The dataset can then be used in the AI model platform 111 to query, conduct exploratory analysis, and establish a preprocessing pipeline where the AI models are trained and built. A deployment comprising an interactive connection between an AI model endpoint 242 and a local AI model reference 222 is established to provide various forms of AI features to the applications and workflow services 119, as well as development tools (not shown). In operation, AI requests from applications are directed to the AI model reference 222, which communicates with the AI model endpoint 242 to access the AI model from the AI model registry 244.

Some AI model implementations use scoring metrics to indicate a confidence level in the results generated by the AI model. Once records within the data service 110 are scored, the automation flow functionality of the applications and workflow services 119 provide for the creation of curated tasks for existing users and/or the automatic inclusion of customers with personalized and tailored communications (e.g., marketing implementations). The activations are created and, as the predictions change, the activations are automatically refreshed and sent to the activation targets.

### G. Example Processes for Integrating AI Services

The following is a specific example use case to highlight some of the benefits of the implementations described herein. Note, however, that many of the specific details provided here are not required for complying with the underlying principles of the invention.

In this example, a product recommendation AI model is generated within the cloud-based application platform. Inferences for product recommendations are imported from the AI model platform 111 (e.g., Google Vertex AI in one embodiment) using the extreme gradient boosting (XGBoost) classification model, which is a well known machine learning model used supervised learning tasks such as classifications, regression, and rankings.

In this example use case, a retailer subscribes to various services of the cloud-based application platform 115, including sales, service, and marketing services. The retailer will benefit from predicting their customers' product preferences in order to deliver personalized recommendations of products that are most likely to spark interest. In this example, the retailer's data from the data service 110 is leveraged to develop AI models to forecast an individual's product preferences, allowing for precise marketing campaigns driven by AI model insights. It also increases customer engagement via automated tasks for service representatives to reach out to customers proactively.

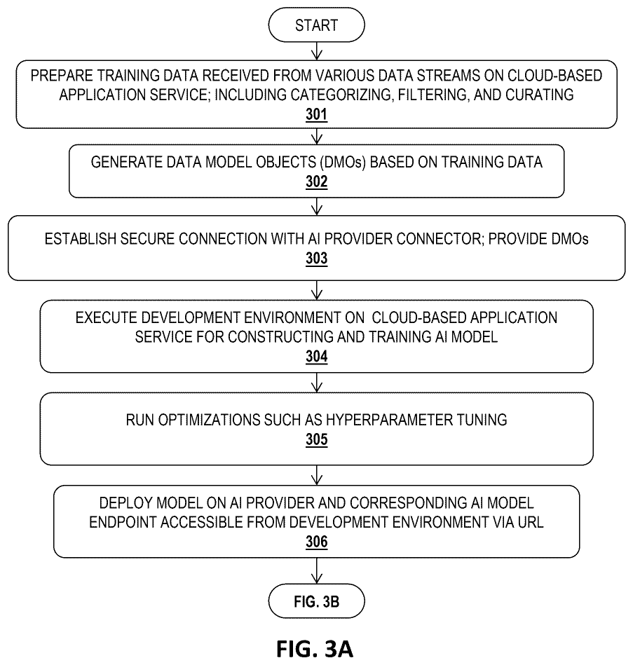

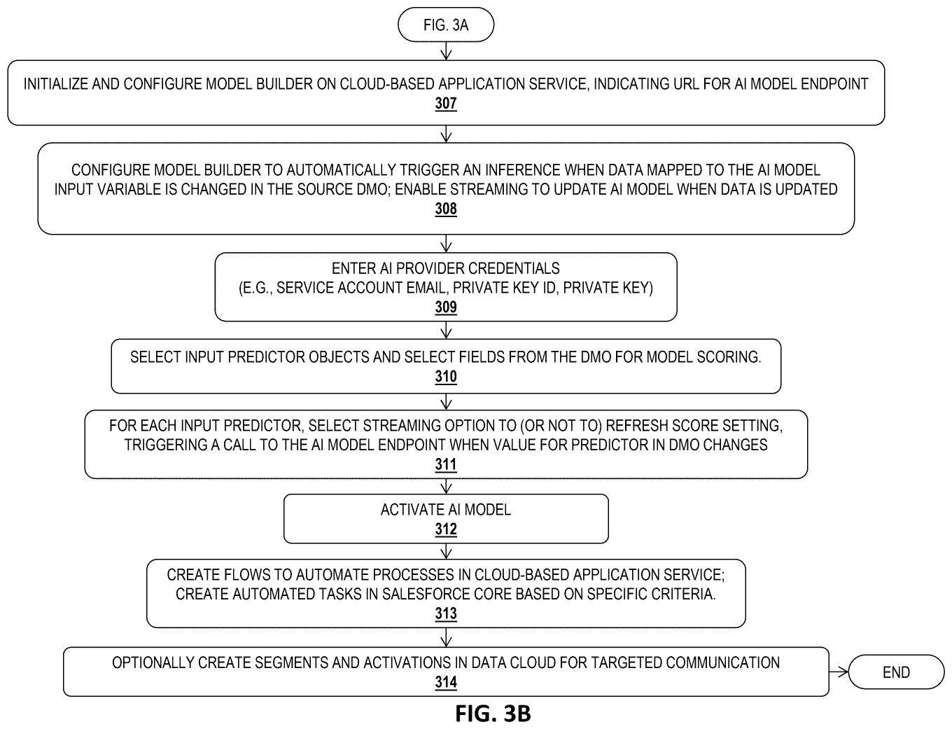

A method in accordance with this example embodiment is illustrated in FIGS. 3A-B. It should be noted, however, that some of these specific details are not required for complying with the underlying principles of the invention. Starting at 301, training data received from various data streams is prepared for AI processing. This preparation can include categorizing, filtering, and curating the raw data from the data stream.

At 302, data model objects (DMOs) are generated based on the prepared training data. In one specific, non-limiting implementation, the AI model for product recommendations is constructed based on a dataset of historical information encompassing the following information in the DMOs:
Customer Demographics: Customer-specific information, such as location, age range, Customer Satisfaction (CSAT) or Net Promoter Score (NPS), and loyalty status;
Case Records: Prior purchases, including the total number of support cases, and if any of the cases were escalated for resolution;
Purchase History: Comprehensive information about products purchased and the purchase dates; and
Website and Engagement Metrics: Metrics related to the customer's website interactions, such as the number of visits, clicks, and engagement score.

At 303, a secure connection is established between the cloud-based application platform 115 and the AI model platform 111 over which the generated DMOs are shared with the data service integration component 245. At 304, an AI development tool/application or other development environment is executed on the cloud-based application service for constructing and training the AI model. Model training and deployment then take place in the AI model building and training logic 244 of the AI model platform 111 (e.g., Google Vertex AI in one implementation). As mentioned, the data service integration logic 245 may be implemented as a Python SDK connector, allowing the DMO-based data share 240 to be imported into the AI model building and training logic 244.

Once the data has been imported into the AI model building and training logic 244, various forms of development tools may be used. For example, for a Google Vertex AI implementation, the Google Vertex AI Workbench, a Jupyter notebook-based development environment may be used to build and train the AI model. The Jupyter notebook application allows a user to query for the input features to be input to the AI model, such as products purchased, club member status, and various other relevant data items.

Returning to FIG. 3A, at 305, optimizations may be executed on the AI model such as Optionally, at 305, optimizations are executed such as hyperparameter tuning, which can be used to systematically adjust the parameters and select the best algorithm. Hyperparameter tuning helps to maximize the performance of AI models on a dataset. The optimization involves techniques, such as grid search or random search, cross-validation, and careful evaluation of performance metrics, ensuring the model's ability to perform on new data.

At 306, the tuned AI model is deployed on the AI provider and a corresponding AI model endpoint is generated (e.g., such as endpoint 242 previously described), which is made accessible via a URL or other form of network address. As mentioned, a model endpoint enables the scoring of records within the data service 110. The URL of the model endpoint can then be used to request or invoke the corresponding AI model by the data service 110 by providing an interface to send requests (input data) to a trained model and receive the inferencing (scoring) results back from the model—and communicate the results to the data service 110.

At 307, the model builder is initialized and configured on the cloud-based application service, indicating the URL for the AI model endpoint. Once the AI model endpoint 242 is created, it is relatively simple to configure the model in the data service 110 using a no-code interface (e.g., simply by entering the URL).

At 308, the model builder may be configured to automatically trigger an inference when data mapped to the AI model input variable is changed in the source DMO. In some implementations, this is a user-selectable option which enables streaming to dynamically trigger an update to the AI model when the corresponding data is updated.

At 309, if not already authenticated to the AI model platform, the AI provider credentials are entered (e.g., service account email, private key ID, private key). Any other required authentication techniques may be required such as multi-stage authentication or use of an authentication device.

At 310, the input predictor objects and the corresponding fields are selected from the DMO for model scoring. Note that in a Google Vertex AI implementation, the order in which the fields are selected may be relevant and should match up with the SELECT query in Google Vertex AI. If the predictors are across multiple objects, the records are harmonized and can be scored.

At 311, for each input predictor, the streaming option is selected to (or not to) refresh the score setting, triggering a call to the AI model endpoint when the value for the predictor in the DMO changes. Additionally, the outcome variable API name is entered as well as the JSON key. Note that in one specific implementation, the JSON key is: $.predictions.product_purchased_c since the original query has product interest as the outcome variable name.

At 312, the AI model is activated to service requests from the various software components within the cloud-based application platform. At 313, flows may be created to automate processes in cloud-based application service. These flows can be defined to create automated tasks in the cloud-based application platform based on specific criteria. At 314, segments and activations are optionally created in the data service 110 for targeted communication.

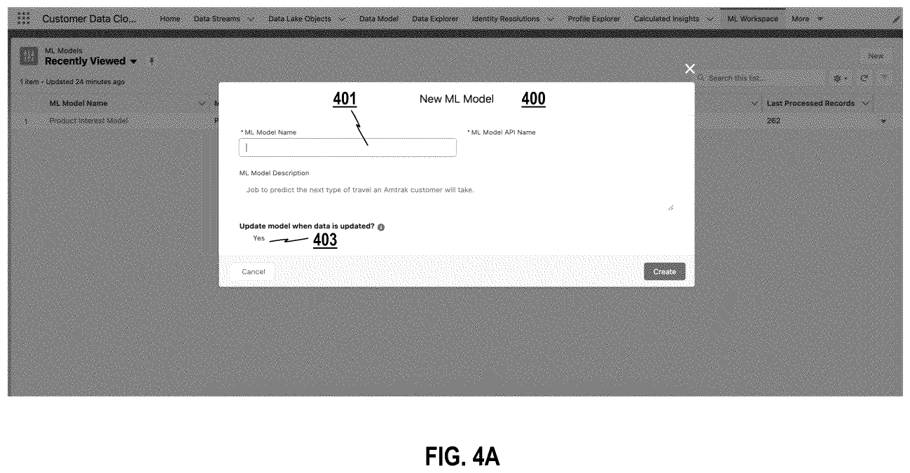

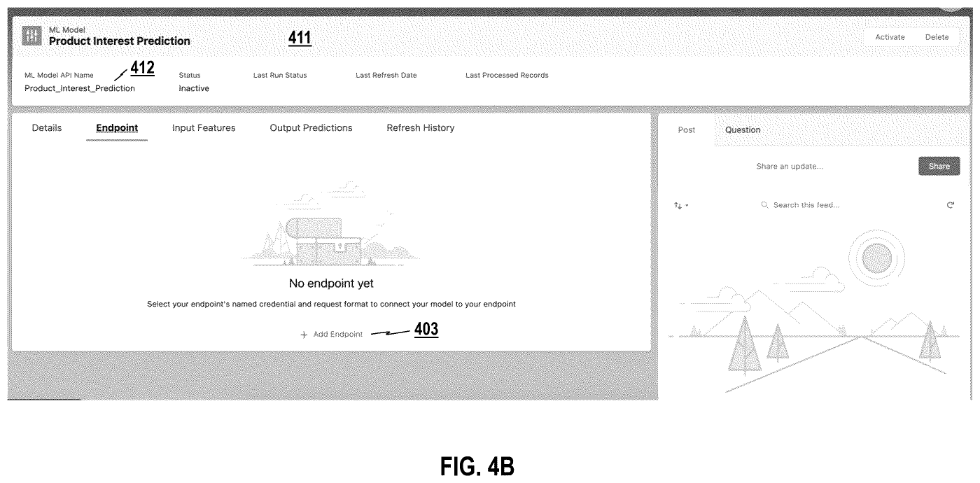

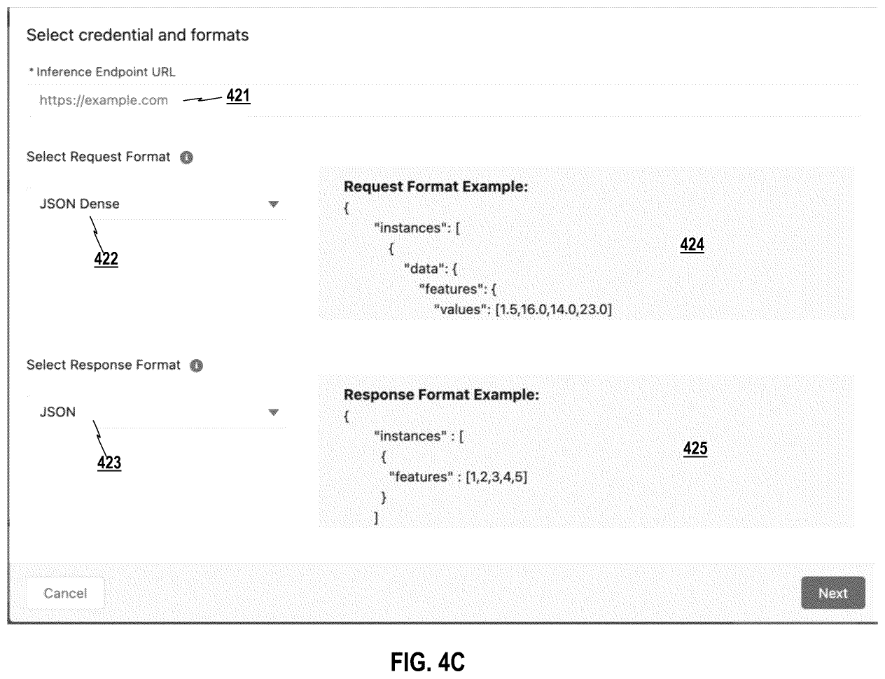

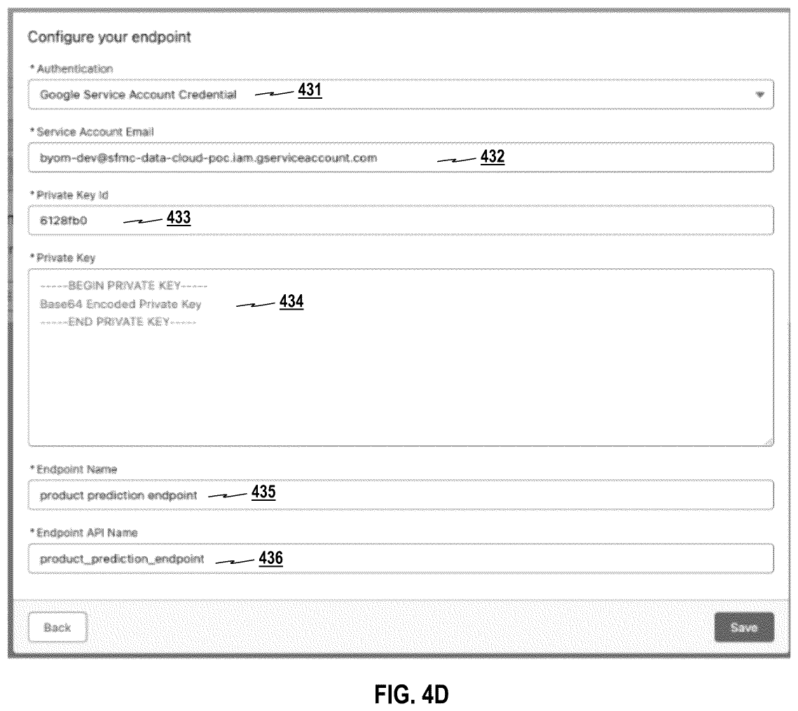

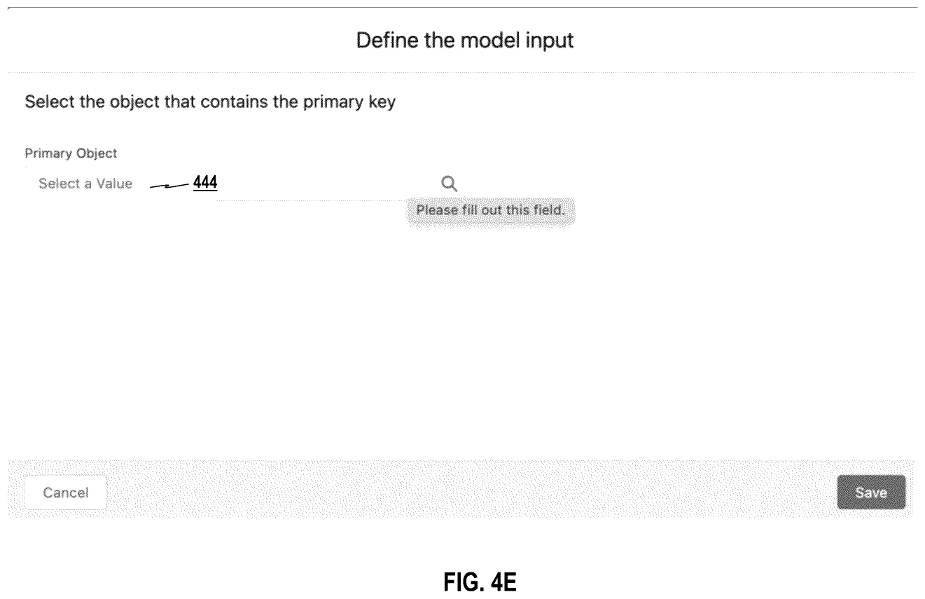

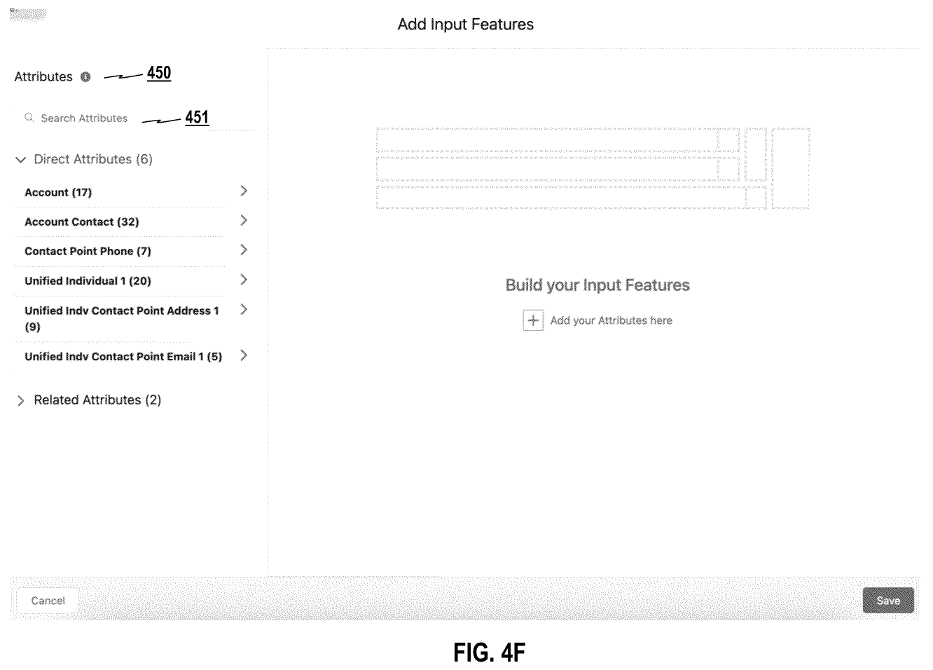

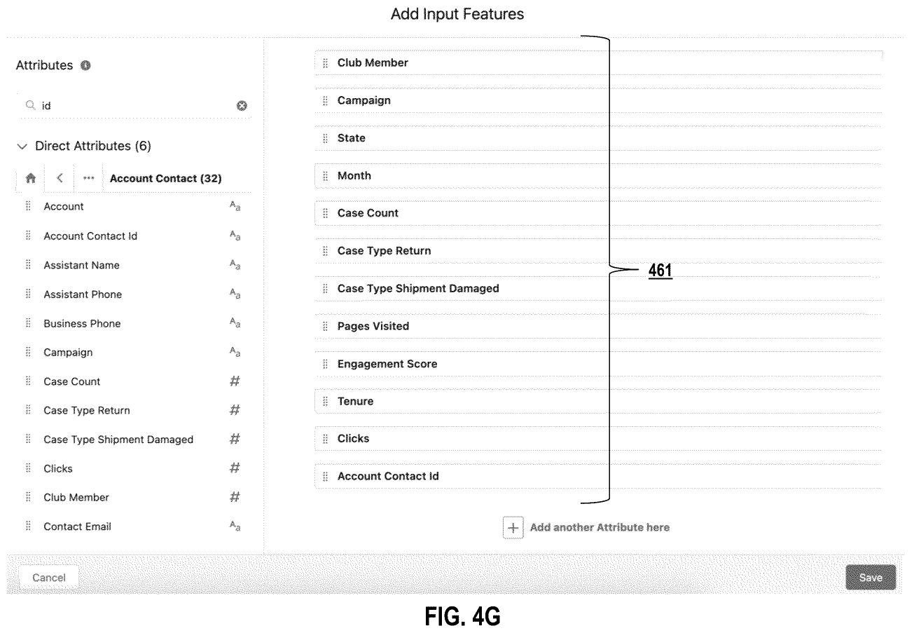

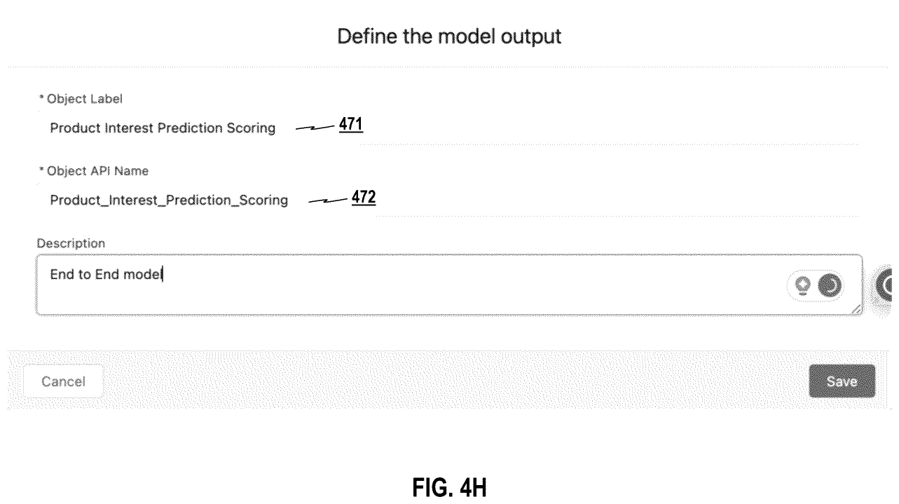

An example set of graphical user interface (GUI) features of the model builder 221 are illustrated in FIGS. 4A-H. FIG. 4A illustrates a window 400 generated to enter a new model, including a field 401 for entering a model name and a selection box 403 to indicate whether the model is to be dynamically updated in response to updates to the underlying data.

FIG. 4B illustrates a window 411 generated once the user has entered the information for the new model, including the model name 412 and any associated endpoints (which have not yet been assigned). An add endpoint button 403 allows the user to specify a corresponding endpoint for the new model.

FIG. 4C illustrates a window allowing a user to enter the endpoint URL 421 and to indicate a request format 422 and a response format 423, as well as corresponding examples of each 424, 425, respectively.

FIG. 4D illustrates a window for configuring the endpoint, including a field 431 for indicating the AI service account credentials 431, the service account email 432, the private key ID 433, the private key 434, the endpoint name 435, and the endpoint API name 436.

FIG. 4E provides a field 444 to select the primary object that has the predictors. FIG. 4F provides options to identify attributes for input features 450, including a search field 451 for specific attributes.

FIG. 4G illustrates a list 461 of selected attributes from the options in FIG. 4F.

FIG. 4H provides fields for defining the model output including an object label 471 and an object API name 472.

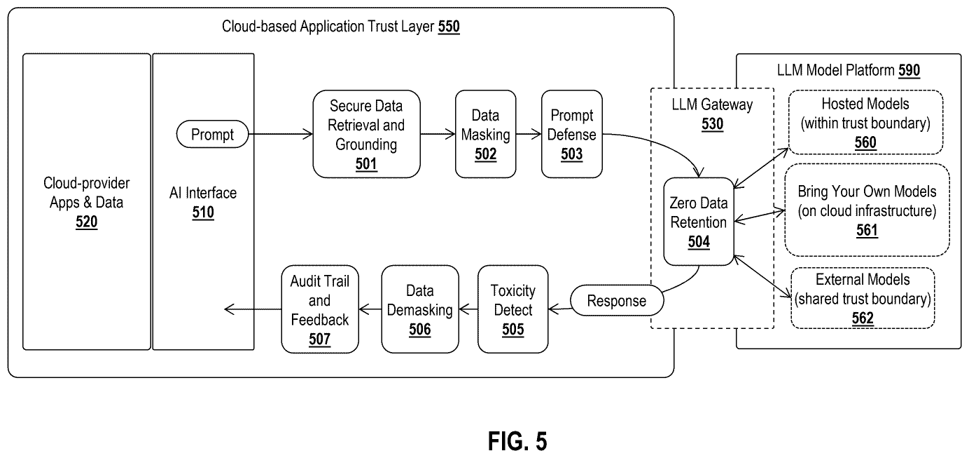

FIG. 5 illustrates a specific implementation for a large language model (LLM) implementation with a cloud-provider applications and data 520 and an AI interface 510 operating within a cloud-based application trust layer 550. An LLM gateway 530 securely connects the cloud-based application trust layer 550 to an LLM model platform 590, which provides a set of LLM models 560-562.

In this example, a prompt generated via the AI interface 510 performs secure data retrieval and grounding 501 from within the Cloud-based Application Trust Layer 550. In this example, a grounding search on unstructured and structured data enhances your use of generative AI, analytics, and automation tools. At 502, data masking is performed which, depending on the configuration, determines the privacy of sensitive information and how that data is surfaced in a prompt response. In addition to data masking, various types of prompt defenses 503 may be performed such as filtering out confidential or otherwise proprietary information from the prompt. System policies help limit hallucinations and decrease the likelihood of unintended or harmful outputs by the LLM. System policies can vary for different generative AI features and use cases.

The resulting prompt is received by the LLM gateway 530 coupling the cloud-based application trust layer 550 to the LLM model platform 590. As indicated, the LLM gateway 530 and corresponding models 560-562 within the LLM platform 590 performs zero data retention 504. That is, the data is not retained by any third-party LLMs and relationships are formed with Open AI and Azure Open AI to enforce the zero-data retention policy. No data is used for LLM model training or product improvements by third-party LLMs, no data is retained by the third-party LLMs, and no human being at the third-party provider looks at data sent to their LLM.

The selected LLM model 560-562 processes the prompt and generates a response, transmitted back through the LLM gateway 530. Toxicity detection 505 is performed. For example, Trust Layer scores based on toxicity are generated, logged and stored in the data service as part of the audit trail. Data demasking 506 is then performed to unmask the data which was masked at 502. Finally, an audit trail and feedback 507 is provided via the AI interface 510. For example, prompts, responses, and trust signals are logged and stored in the data service, feedback can be used for improving prompt templates; and pre-built reports and dashboards are provided for analysis.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

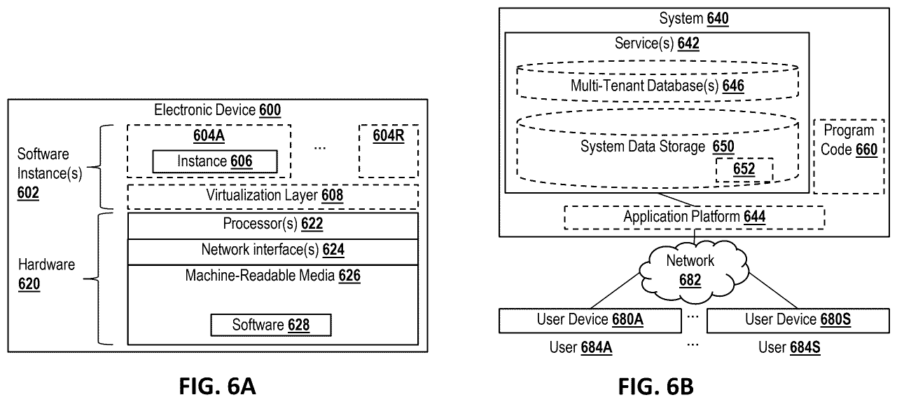

FIG. 6A is a block diagram illustrating an electronic device 600 according to some example implementations. FIG. 6A includes hardware 620 comprising a set of one or more processor(s) 622, a set of one or more network interfaces 624 (wireless and/or wired), and machine-readable media 626 having stored therein software 628 (which includes instructions executable by the set of one or more processor(s) 622). The machine-readable media 626 may include non-transitory and/or transitory machine-readable media to be executed by one or more electronic devices, such as server hardware (comprising a memory and a plurality of execution cores). Some of the components described above, enter into transactions with other components through a request-response protocol (e.g., such as request sent to access the AI model platforms). In this arrangement, a component sending a request is a “client” with respect to that transaction and the component providing the response is the “server”. Various components described herein may perform the role of client and server (depending on whether they are sending a request or receiving a request and providing a response). In one implementation: 1) each of the components is implemented in a separate one of the electronic devices 600; 2) each component is implemented in a separate set of one or more of the electronic devices 600 (e.g., a set of one or more server devices where the software 628 represents the functional modules described herein software to implement the corresponding functions); and 3) in operation, the electronic devices implementing the components would be communicatively coupled (e.g., by a network) and would establish between them (or through one or more other layers and/or or other services) connections for communicating requests and receiving responses as described herein. Other configurations of electronic devices may be used in other implementations.

During operation, an instance of the software 628 (illustrated as instance 606 and referred to as a software instance; and in the more specific case of an application, as an application instance) is executed. In electronic devices that use compute virtualization, the set of one or more processor(s) 622 typically execute software to instantiate a virtualization layer 608 and one or more software container(s) 604A-604R (e.g., with operating system-level virtualization, the virtualization layer 608 may represent a container engine (such as Docker Engine by Docker, Inc. or rkt in Container Linux by Red Hat, Inc.) running on top of (or integrated into) an operating system, and it allows for the creation of multiple software containers 604A-604R (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers 604A-604R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 628 is executed within the software container 604A on the virtualization layer 608. In electronic devices where compute virtualization is not used, the instance 606 on top of a host operating system is executed on the “bare metal” electronic device 600. The instantiation of the instance 606, as well as the virtualization layer 608 and software containers 604A-604R if implemented, are collectively referred to as software instance(s) 602.

Alternative implementations of an electronic device may have numerous variations from that described above. For example, customized hardware and/or accelerators might also be used in an electronic device.

### Example Environment

FIG. 6B is a block diagram of a deployment environment according to some example implementations. A system 640 includes hardware (e.g., a set of one or more server devices) and software to provide service(s) 642, including the data service 110, application and workflow services 119, and other components of the cloud-based application platform 115. In some implementations the system 640 is in one or more datacenter(s). These datacenter(s) may be: 1) first party datacenter(s), which are datacenter(s) owned and/or operated by the same entity that provides and/or operates some or all of the software that provides the service(s) 642; and/or 2) third-party datacenter(s), which are datacenter(s) owned and/or operated by one or more different entities than the entity that provides the service(s) 642 (e.g., the different entities may host some or all of the software provided and/or operated by the entity that provides the service(s) 642). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 640 is coupled to user devices 680A-680S over a network 682. The service(s) 842 may be on-demand services that are made available to one or more of the users 884A-884S working for one or more entities other than the entity which owns and/or operates the on-demand services (those users sometimes referred to as outside users) so that those entities need not be concerned with building and/or maintaining a system, but instead may make use of the service(s) 842 when needed (e.g., when needed by the users 884A-884S). The service(s) 842 may communicate with each other and/or with one or more of the user devices 880A-880S via one or more APIs (e.g., a REST API). In some implementations, the user devices 880A-880S are operated by users 884A-884S, and each may be operated as a client device and/or a server device. In some implementations, one or more of the user devices 880A-880S are separate ones of the electronic device 800 or include one or more features of the electronic device 800.

In some implementations, the system 840 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 840 is a multi-tenant cloud computing architecture supporting multiple services, such as one or more of the following types of services: Pricing; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Cache-as-a-Service (CaaS); Analytics; Community; Internet-of-Things (IoT); Industry-specific; Artificial intelligence (AI); Application marketplace (“app store”); Data modeling; Security; and Identity and access management (IAM).

For example, system 840 may include an application platform 844 that enables PAAS for creating, managing, and executing one or more applications developed by the provider of the application platform 844, users accessing the system 840 via one or more of user devices 880A-880S, or third-party application developers accessing the system 840 via one or more of user devices 880A-880S.

In some implementations, one or more of the service(s) 842 may use one or more multi-tenant databases 846, as well as system data storage 850 for system data 852 accessible to system 840. In certain implementations, the system 840 includes a set of one or more servers that are running on server electronic devices and that are configured to handle requests for any authorized user associated with any tenant (there is no server affinity for a user and/or tenant to a specific server). The user devices 880A-880S communicate with the server(s) of system 840 to request and update tenant-level data and system-level data hosted by system 840, and in response the system 840 (e.g., one or more servers in system 840) automatically may generate one or more Structured Query Language (SQL) statements (e.g., one or more SQL queries) that are designed to access the desired information from the multi-tenant database(s) 846 and/or system data storage 850.

In some implementations, the service(s) 842 are implemented using virtual applications dynamically created at run time responsive to queries from the user devices 880A-880S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 860 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 844 includes an application setup mechanism that supports application developers' creation and management of applications, which may be saved as metadata by save routines. Invocations to such applications may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 882 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 840 and the user devices 880A-880S.

Each user device 880A-880S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 840. For example, the user interface device can be used to access data and applications hosted by system 840, and to perform searches on stored data, and otherwise allow one or more of users 884A-884S to interact with various GUI pages that may be presented to the one or more of users 884A-884S. User devices 880A-880S might communicate with system 840 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 880A-880S might include an HTTP client, commonly referred to as a “browser,” for sending and receiving HTTP messages to and from server(s) of system 840, thus allowing users 884A-884S of the user devices 880A-880S to access, process and view information, pages and applications available to it from system 840 over network 882.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims.

What is claimed is:

1. A method implemented in a set of one or more electronic devices of a cloud-based application service to securely integrate AI models hosted by at least one external AI service, the method comprising:
preparing training data received from various data streams on the cloud-based application service, wherein preparing includes categorizing, filtering, and curating data from the data streams;
generating source data model objects (DMOs) based on training data;
providing the source DMOs to the external AI service over a secure communication channel, the external AI service to register an AI model based on the source DMOs and to generate a corresponding AI model endpoint;
executing an AI model builder on the cloud-based application service, the AI model builder to generate an AI model reference configurable with connection information to communicate with the AI model endpoint, the AI model builder configurable to automatically trigger an inference when data mapped to an input of the AI model is changed in one or more of the source DMOs.

2. The method of claim 1, further comprising:
activating the AI model reference for access by applications hosted on the cloud-based application service, wherein responsive to requests to access the AI mode, the AI model reference is to communicate with the AI model endpoint to access the AI model on the external AI service.

3. The method of claim 1, wherein the connection information to communicate with the AI model endpoint comprises a uniform resource locator (URL) provided by the external AI model service.

4. The method of claim 1, wherein automatically triggering the inference responsive to changes to the one or more of the source DMOs further comprises responsively communicating with the AI model endpoint to cause updates to the corresponding AI model.

5. The method of claim 1, wherein the AI model builder comprises a component of a development platform operable on the cloud-based application service, the development platform further comprising an application development environment to create flows to automate processes and create automated tasks in the cloud-based application service based on specific criteria, the automated processes and tasks configurable to access the AI model via the AI model representation.

6. The method of claim 5, wherein accessing the AI model comprises transmitting requests to the AI model representation, the AI model representation to responsively transmit the requests, or corresponding modified requests, to the AI model endpoint and to receive responses from the AI model endpoint generated by the AI model.

7. The method of claim 1, wherein the AI model comprises a predictive AI model or a generative AI model.

8. The method of claim 7, wherein the generative AI model comprises a Large Language Model (LLM).

9. The method of claim 1, wherein preparing training data and/or generating source data model objects (DMOs) further comprises:
selecting input predictor objects and selecting fields from the DMOs for model scoring; and
for each input predictor, if a streaming option is selected to refresh the scoring, triggering the AI model representation to make a call to the AI model endpoint when a value for a predictor in a DMO changes.

10. The method of claim 1, further comprising:
creating segments and activations in a data service of the cloud-based application service for targeted communication based on results produced by the AI model.

11. The method of claim 1, wherein the AI model comprises a first AI model of a plurality of AI models provided by a plurality of external AI services, the method further comprising, for at least a second AI model of the plurality of AI models:
preparing second training data received from second data streams on the cloud-based application service, wherein preparing includes categorizing, filtering, and curating data from the second data streams;
generating second source data model objects (DMOs) based on second training data;
providing the second source DMOs to a second external AI service over a secure communication channel, the second external AI service to register a second AI model based on the second source DMOs and to generate a corresponding second AI model endpoint;
executing the AI model builder on the cloud-based application service, the AI model builder to generate a second AI model reference configurable with connection information to communicate with the second AI model endpoint, the AI model builder configurable to automatically trigger a second inference when second data mapped to an input of the second AI model is changed in one or more of the second source DMOs.

12. A non-transitory machine readable storage medium having program code stored thereon which, when executed by one or more electronic devices, is to cause the one or more electronic devices to perform operations, comprising:
preparing training data received from various data streams on the cloud-based application service, wherein preparing includes categorizing, filtering, and curating data from the data streams;
generating source data model objects (DMOs) based on training data;
providing the source DMOs to the external AI service over a secure communication channel, the external AI service to register an AI model based on the source DMOs and to generate a corresponding AI model endpoint;
executing an AI model builder on the cloud-based application service, the AI model builder to generate an AI model reference configurable with connection information to communicate with the AI model endpoint, the AI model builder configurable to automatically trigger an inference when data mapped to an input of the AI model is changed in one or more of the source DMOs.

13. The non-transitory machine readable storage medium of claim 12, further comprising program code to cause the one or more electronic devices to perform the operations of:
activating the AI model reference for access by applications hosted on the cloud-based application service, wherein responsive to requests to access the AI mode, the AI model reference is to communicate with the AI model endpoint to access the AI model on the external AI service.

14. The non-transitory machine readable storage medium of claim 12, wherein the connection information to communicate with the AI model endpoint comprises a uniform resource locator (URL) provided by the external AI model service.

15. The non-transitory machine readable storage medium of claim 12, wherein automatically triggering the inference responsive to changes to the one or more of the source DMOs further comprises responsively communicating with the AI model endpoint to cause updates to the corresponding AI model.

16. The non-transitory machine readable storage medium of claim 12, wherein the AI model builder comprises a component of a development platform operable on the cloud-based application service, the development platform further comprising an application development environment to create flows to automate processes and create automated tasks in the cloud-based application service based on specific criteria, the automated processes and tasks configurable to access the AI model via the AI model representation.

17. The non-transitory machine readable storage medium of claim 16, wherein accessing the AI model comprises transmitting requests to the AI model representation, the AI model representation to responsively transmit the requests, or corresponding modified requests, to the AI model endpoint and to receive responses from the AI model endpoint generated by the AI model.

18. The non-transitory machine readable storage medium of claim 12, wherein the AI model comprises a predictive AI model or a generative AI model.

19. The non-transitory machine readable storage medium of claim 18, wherein the generative AI model comprises a Large Language Model (LLM).

20. The non-transitory machine readable storage medium of claim 12, wherein preparing training data and/or generating source data model objects (DMOs) further comprises:
selecting input predictor objects and selecting fields from the DMOs for model scoring; and
for each input predictor, if a streaming option is selected to refresh the scoring, triggering the AI model representation to make a call to the AI model endpoint when a value for a predictor in a DMO changes.

21. The non-transitory machine readable storage medium of claim 12, further comprising:
creating segments and activations in a data service of the cloud-based application service for targeted communication based on results produced by the AI model.

22. The non-transitory machine readable storage medium of claim 12, wherein the AI model comprises a first AI model of a plurality of AI models provided by a plurality of external AI services, the non-transitory machine readable storage medium further comprising program code to cause operations with respect to at least a second AI model of the plurality of AI models, the operations comprising:
preparing second training data received from second data streams on the cloud-based application service, wherein preparing includes categorizing, filtering, and curating data from the second data streams;
generating second source data model objects (DMOs) based on second training data;
providing the second source DMOs to a second external AI service over a secure communication channel, the second external AI service to register a second AI model based on the second source DMOs and to generate a corresponding second AI model endpoint;
executing the AI model builder on the cloud-based application service, the AI model builder to generate a second AI model reference configurable with connection information to communicate with the second AI model endpoint, the AI model builder configurable to automatically trigger a second inference when second data mapped to an input of the second AI model is changed in one or more of the second source DMOs.
